(19) United States
(12) Patent Application Publication
(10) Pub. No.: US 2020/0141741 A1
(43) Pub. Date: May 7, 2020

(54) SYSTEMS AND METHODS FOR DETERMINING RECOMMENDED INFORMATION OF A SERVICE REQUEST

(71) Applicant: BEIJING DIDI INFINITY TECHNOLOGY AND DEVELOPMENT CO., LTD., Beijing (CN)

(72) Inventors: Zheng WANG, Beijing (CN); Yinghao JIA, Beijing (CN)

(73) Assignee: BEIJING DIDI INFINITY TECHNOLOGY AND DEVELOPMENT CO., LTD., Beijing (CN)

(21) Appl. No.: 16/729,277

(22) Filed: Dec. 27, 2019

Related U.S. Application Data
(63) Continuation of application No. PCT/CN2017/093562, filed on Jul. 19, 2017.

(51) Int. Cl. G01C 21/34; G06Q 30/02; H04W 4/029; H04W 4/40

(52) U.S. Cl. CPC G01C 21/3438; G06Q 30/0282; H04W 4/40; G01C 21/3492; H04W 4/029; G01C 21/343

(57) ABSTRACT

The present disclosure relates to systems and methods for determining recommended information of a service request. The systems may perform the methods to obtain a service request from a terminal including a target location; obtain a target region based on the target location, wherein the target region is associated with a target link so that a predetermined percentage of historical service orders associated with the target region is associated with the target link; determine recommended information associated with the service request based at least in part on the target link; and send out the recommended information to the terminal.

### CROSS-REFERENCE TO RELATED APPLICATIONS

This application is a continuation of International Application No. PCT/CN2017/093562, filed on Jul. 19, 2017, which designates the United States of America, the contents of which are incorporated herein by reference in their entirety.

### TECHNICAL FIELD

The present disclosure generally relates to systems and methods for on-demand services, and in particular, to systems and methods for determining recommended information associated with a service request for an on-demand service.

### BACKGROUND

On-demand transportation services utilizing Internet technology, such as online taxi services, have become increasingly popular because of their convenience. A system providing on-demand services may obtain a service request including a service location (e.g., a start location, a destination) from a requestor and determine recommended information (e.g., a recommended driving route that starts or ends at the service location) for the requestor. However, in some situations, the service location may be a location where a vehicle cannot stop, in order to determine the recommended driving route, the system should determine a suitable location or a suitable link where a vehicle can stop corresponding to the service location.

### SUMMARY

According to a first aspect of the present disclosure, a system is provided. The system may include at least one storage medium and at least one processor in communication with the at least one storage medium. The at least one storage medium may include a set of instructions for determining recommended information of a service request. When executing the set of instructions, the at least one processor may be directed to perform one or more of the following operations. The at least one processor may obtain a service request from a terminal including a target location. The at least one processor may obtain a target region based on the target location, wherein the target region may be associated with a target link so that a predetermined percentage of historical service orders associated with the target region may be associated with the target link. The at least one processor may determine recommended information associated with the service request based at least in part on the target link. The at least one processor may send out the recommended information to the terminal.

According to a second aspect of the present disclosure, a method is provided. The method may be implemented on a computing device having at least one processor, at least one storage medium, and a communication platform connected to a network. The method may include one or more of the following operations. The at least one processor may obtain a service request from a terminal including a target location. The at least one processor may obtain a target region based on the target location, wherein the target region may be associated with a target link so that a predetermined percentage of historical service orders associated with the target region may be associated with the target link. The at least one processor may determine recommended information associated with the service request based at least in part on the target link. The at least one processor may send out the recommended information to the terminal.

According to a third aspect of the present disclosure, a non-transitory computer readable medium is provided. The non-transitory computer readable medium may include a set of instructions for determining recommended information of a service request. When executed by at least one processor, the set of instructions may direct the at least one processor to perform one or more of the following acts. The at least one processor may obtain a service request from a terminal including a target location. The at least one processor may obtain a target region based on the target location, wherein the target region may be associated with a target link so that a predetermined percentage of historical service orders associated with the target region may be associated with the target link. The at least one processor may determine recommended information associated with the service request based at least in part on the target link. The at least one processor may send out the recommended information to the terminal.

In some embodiments, the target location may include at least one of a start location or a destination. The target link may correspond to a road section associated with the target location.

In some embodiments, the recommended information may include a recommended driving route that starts or ends at the road section corresponding to the target link.

In some embodiments, the predetermined percentage may be 100%.

In some embodiments, the at least one processor may obtain a plurality of historical service orders, wherein each of the plurality of historical service orders may include a sample service end-point location in an end-point region associated with the historical service order, and wherein the sample service end-point location may correspond to a sample service end-point link where a corresponding service of the historical service order started or ended. The at least one processor may determine a plurality of sub-end-point regions within the end-point region based at least in part on the plurality of sample service end-point locations and the plurality of sample service end-point links, wherein each sub-end-point region may be associated with a single corresponding end-point link so that the predetermined percentage of the plurality of historical service orders started or ended the corresponding services at the single corresponding end-point link.

In some embodiments, the target link may be one of the plurality of single corresponding end-point links. The target region may be one of the plurality of sub-end-point regions where the target location falls in.

In some embodiments, the at least one processor may determine a plurality of preliminary sub-end-point regions within the end-point region. The at least one processor may determine a plurality of relationships between the plurality of sample service end-point locations and the plurality of service end-point links. The at least one processor may fill the plurality of sample service end-point locations and the plurality of sample service end-point links into the plurality of preliminary sub-end-point regions. For each of the plurality of preliminary sub-end-point regions, the at least one processor may determine whether a single sample service end-point link is in the sub-end-point region and whether all the sample service end-point locations in the sub-end-point region correspond to the single sample service end-point link based on the plurality of relationships. The at least one processor may designate the plurality of preliminary sub-end-point regions as the plurality of sub-end-point regions in response to the determination that a single sample service end-point link is in the sub-end-point region and all the sample service end-point locations in the sub-end-point region correspond to the single sample service end-point link based on the plurality of relationships.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-demand service system according to some embodiments of the present disclosure;

FIG. 2 is a schematic diagram illustrating an exemplary computing device in the on-demand service system according to some embodiments of the present disclosure;

FIG. 3 is a schematic diagram illustrating an exemplary mobile device in the on-demand service system according to some embodiments of the present disclosure;

FIG. 4 is a block diagram illustrating an exemplary processing engine according to some embodiments of the present disclosure;

FIG. 5 is a flowchart illustrating an exemplary process for determining recommended information associated with a service request according to some embodiments of the present disclosure;

FIG. 6 is a flowchart illustrating an exemplary process for determining a plurality of trained sub-end-point regions according to some embodiments of the present disclosure; and

FIG. 7 is a schematic diagram illustrating an example for determining a recommended driving route associated with a service request based on a plurality of trained sub-end-point regions according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding an on-demand transportation service, it should also be understood that this is only one exemplary embodiment. The system or method of the present disclosure may be applied to any other kind of on-demand services. For example, the system or method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for transmitting and/or receiving an express. The application scenarios of the system or method of the present disclosure may include a web page, a plug-in of a browser, a client terminal, a custom system, an internal analysis system, an artificial intelligence robot, or the like, or any combination thereof.

The terms “passenger,” “requestor,” “service requestor,” and “customer” in the present disclosure are used interchangeably to refer to an individual, an entity or a tool that may request or order a service. Also, the terms “driver,” “provider,” “service provider,” and “supplier” in the present disclosure are used interchangeably to refer to an individual, an entity, or a tool that may provide a service or facilitate the providing of the service. The term “user” in the present disclosure may refer to an individual, an entity, or a tool that may request a service, order a service, provide a service, or facilitate the providing of the service. For example, the user may be a passenger, a driver, an operator, or the like, or any combination thereof. In the present disclosure, terms “passenger” and “passenger terminal” may be used interchangeably, and terms “driver” and “driver terminal” may be used interchangeably.

The term “service request” in the present disclosure refers to a request that initiated by a passenger, a requestor, a service requestor, a customer, a driver, a provider, a service provider, a supplier, or the like, or any combination thereof. The service request may be accepted by any one of a passenger, a requestor, a service requestor, a customer, a driver, a provider, a service provider, or a supplier. The service request may be chargeable, or free.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure provides online systems and methods for determining recommended information (e.g., a recommended driving route, an estimated time of arrival) associated with a service request for an on-demand service, such as taxi service. When a passenger sends a taxi hailing request to an online on-demand transportation service platform, a server of the platform may receive the service request from the passenger's terminal, including a start location and destination of the intended service. Based on the start location, the system may determine a target road link as a pick-up location for the passenger, where historically all service requests sent from the start location or an area associated with the start location were eventually ended up with starting the corresponding service at the target link. The server may also do the same to the location where the passenger will end the taxi service by recommending another target road link as an end service location. Also, the server may determine a recommended driving route that starts or ends at the target links.

It should be noted that online on-demand transportation services, such as online taxi hailing, is a new form of service rooted only in post-Internet era. It provides technical solutions to users and service providers that could raise only in post-Internet era. In pre-Internet era, when a user calls for a taxi on street, the taxi request and acceptance occur only between the passenger and one taxi driver that sees the passenger. If the passenger calls a taxi through telephone call, the service request and acceptance may occur only between the passenger and one service provider (e.g., one taxi company or agent). Online taxi hailing, however, allows a user of the service to real-time and automatic distribute a service request to a vast number of individual service providers (e.g., taxi) distance away from the user. It also allows a plurality of service providers to respond to the service request simultaneously and in real-time. Meanwhile, in modern societies, taxi service has become an industry of huge scale. Millions of passengers take taxis every day via online taxi hailing platforms. Only through the help of Internet can studying behaviors of the passengers' taxiing behavior becomes possible. Accordingly, prediction of taxi hailing through a passenger's online taxi hailing activity, is also a new form of service rooted only in post Internet era.

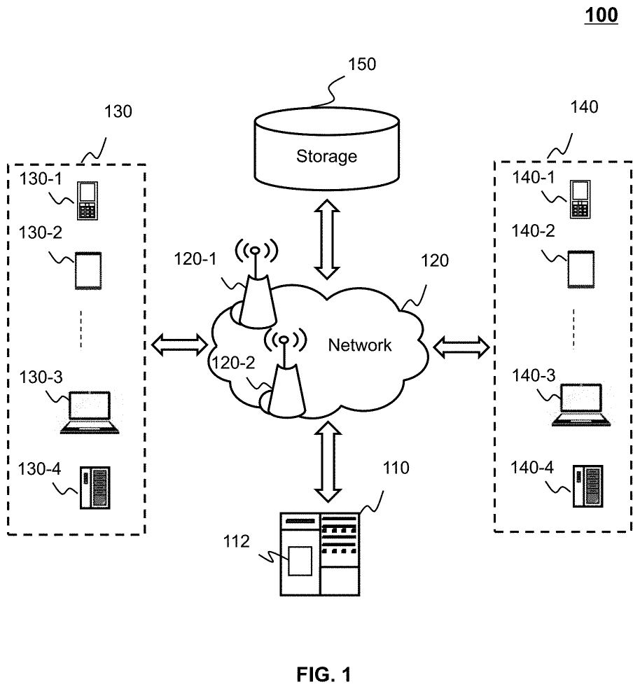

FIG. 1 is a schematic diagram of an exemplary on-demand service system 100 according to some embodiments of the present disclosure. For example, the on-demand service system 100 may be an online transportation service platform for transportation services such as taxi hailing, chauffeur services, delivery vehicles, carpool, bus service, driver hiring, and shuttle services. The on-demand service system 100 may be an online platform including a server 110, a network 120, a requestor terminal 130, a provider terminal 140, and a storage 150. The server 110 may include a processing engine 112.

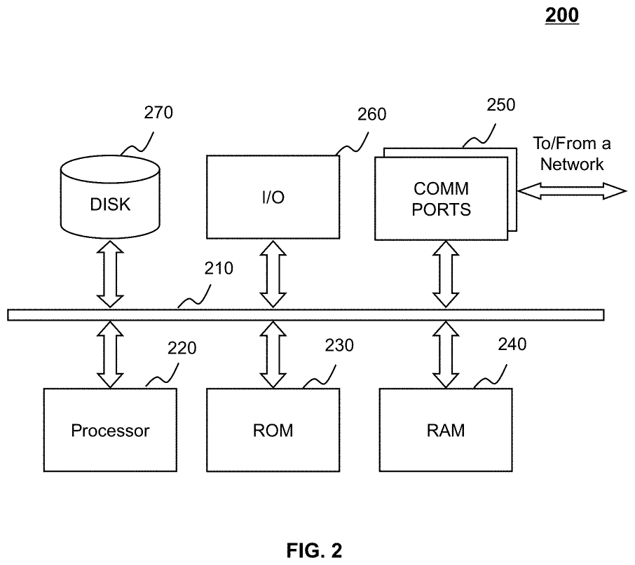

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the storage 150 via the network 120. As another example, the server 110 may connect the requestor terminal 130, the provider terminal 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may perform determine recommended information (e.g., a recommended driving route, an estimated time of arrival) associated with a service request for an on-demand service based on a plurality of trained sub-end-point regions. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the on-demand service system 100 (e.g., the server 110, the requestor terminal 130, the provider terminal 140, and the storage 150) may transmit information and/or data to other component(s) in the on-demand service system 100 via the network 120. For example, the server 110 may receive a service request from the requestor terminal 130 via the network 120. In some embodiments, the network 120 may be any type of wired or wireless network, or combination thereof. Merely by way of example, the network 130 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information between them.

In some embodiments, a requestor may be a user of the requestor terminal 130. In some embodiments, the user of the requestor terminal 130 may be someone other than the requestor. For example, a user A of the requestor terminal 130 may use the requestor terminal 130 to transmit a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may user the provider terminal 140 to receive a service request for a user D, and/or information or instructions from the server 110. In some embodiments, “requestor” and “requestor terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, a RiftCon™, a Fragments™, a Gear VR™, etc. In some embodiments, built-in device in the motor vehicle 130-4 may include an onboard computer, an onboard television, etc. In some embodiments, the requestor terminal 130 may be a device with positioning technology for locating the position of the requestor and/or the requestor terminal 130.

In some embodiments, the provider terminal 140 may be similar to, or the same device as the requestor terminal 130. In some embodiments, the provider terminal 140 may be a device with positioning technology for locating the position of the provider and/or the provider terminal 140. In some embodiments, the requestor terminal 130 and/or the provider terminal 140 may communicate with another positioning device to determine the position of the requestor, the requestor terminal 130, the provider, and/or the provider terminal 140. In some embodiments, the requestor terminal 130 and/or the provider terminal 140 may transmit positioning information to the server 110.

The storage 150 may store data and/or instructions. In some embodiments, the storage 150 may store data obtained from the requestor terminal 130 and/or the provider terminal 140. In some embodiments, the storage 150 may store data and/or instructions that the server 110 may execute or use to perform exemplary methods described in the present disclosure. In some embodiments, the storage 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components of the on-demand service system 100 (e.g., the server 110, the requestor terminal 130, the provider terminal 140). One or more components in the on-demand service system 100 may access the data or instructions stored in the storage 150 via the network 120. In some embodiments, the storage 150 may be directly connected to or communicate with one or more components in the on-demand service system 100 (e.g., the server 110, the requestor terminal 130, the provider terminal 140). In some embodiments, the storage 150 may be part of the server 110.

In some embodiments, one or more components of the on-demand service system 100 (e.g., the server 110, the requestor terminal 130, the provider terminal 140) may access the storage 150. In some embodiments, one or more components of the on-demand service system 100 may read and/or modify information relating to the requester, provider, and/or the public when one or more conditions are met. For example, the server 110 may read and/or modify one or more users' information after a service. As another example, the provider terminal 140 may access information relating to the requestor when receiving a service request from the requestor terminal 130, but the provider terminal 140 may not modify the relevant information of the requestor.

In some embodiments, information exchanging of one or more components of the on-demand service system 100 may be achieved by way of requesting a service. The object of the service request may be any product. In some embodiments, the product may be a tangible product, or immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

It should be noted that the application scenario illustrated in FIG. 1 is only provided for illustration purposes, and not intended to limit the scope of the present disclosure. For example, the on-demand system 100 may be used as a navigation system. The navigation system may include a user terminal (e.g., the requestor terminal 130 or the provider terminal 140) and a server (e.g., the server 110). A user may input a target location (e.g., a start location, a destination) and/or a start time via the user terminal. The navigation system may accordingly determine recommended information (e.g., a recommended driving route, an ETA) based on the target location and/or the start time according to the process and/or method described in this disclosure.

FIG. 2 is a schematic diagram illustrating exemplary hardware and software components of a computing device 200 on which the server 110, the requestor terminal 130, and/or the provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general-purpose computer or a special purpose computer; both may be used to implement an on-demand system for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors, for executing program instructions. The exemplary computing device may include an internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

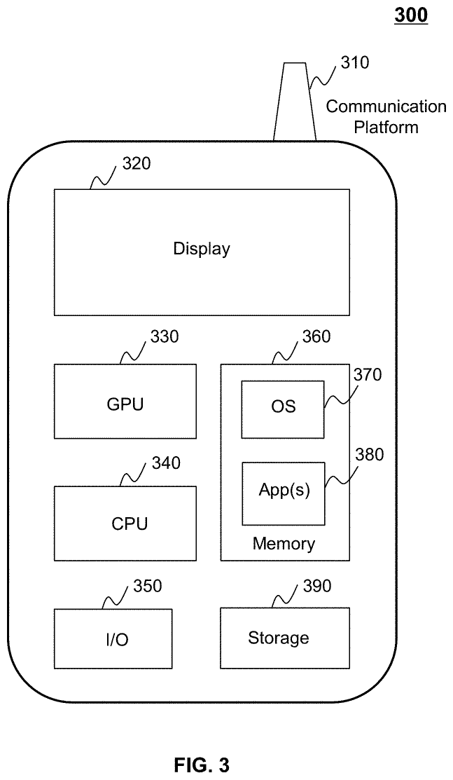

FIG. 3 illustrates an exemplary mobile device on which the on-demand service can be implemented, according to some embodiments of the present disclosure.

As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™′ Windows Phone™, etc.) and one or more applications 380 may be loaded into the memory 360 from the storage 390 in order to be executed by the CPU 340. The applications 380 may include a browser or any other suitable mobile apps for receiving and rendering information associated with a service request (e.g., a start location, a destination) from the processing engine 112 and/or the storage 150. User interactions with the information stream may be achieved via the I/O 350 and provided to the processing engine 112 and/or other components of the on-demand service system 100 via the network 120.

One of ordinary skill in the art would understand that when an element of the on-demand service system 100 performs, the element may perform through electrical signals and/or electromagnetic signals. For example, when a requestor terminal 130 processes a task, such as making a determination, identifying or selecting an object, the requestor terminal 130 may operate logic circuits in its processor to process such task. When the requestor terminal 130 sends out a service request to the server 110, a processor of the service requestor terminal 130 may generate electrical signals encoding the service request. The processor of the requestor terminal 130 may then send the electrical signals to an output port. If the requestor terminal 130 communicates with the server 110 via a wired network, the output port may be physically connected to a cable, which may further transmit the electrical signals to an input port of the server 110. If the requestor terminal 130 communicates with the server 110 via a wireless network, the output port of the requestor terminal 130 may be one or more antennas, which may convert the electrical signals to electromagnetic signals. Similarly, a provider terminal 140 may process a task through operation of logic circuits in its processor, and receive an instruction and/or service request from the server 110 via electrical signals or electromagnet signals. Within an electronic device, such as the requestor terminal 130, the provider terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

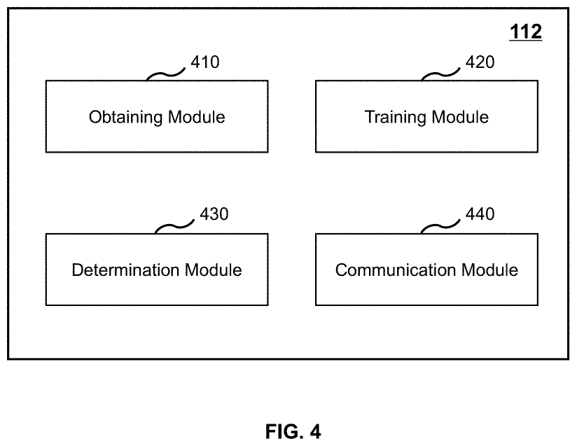

FIG. 4 is a block diagram illustrating an exemplary processing engine 112 according to some embodiments of the present disclosure. The processing engine 112 may include an obtaining module 410, a training module 420, a determination module 430, and a communication module 440.

The obtaining module 410 may be configured to obtain a service request. The obtaining module 410 may obtain the service request from the requestor terminal 130 via the network 120. The service request may be a request for a transportation service (e.g., a taxi service). The service request may include a target location, for example, a start location, a destination, etc. In some embodiments, the obtaining module 410 may further obtain reference information associated with the service request. The reference information may include traffic information associated with the service request, weather information associated with the service request, etc. In some embodiments, the obtained information (e.g., the service request, the reference information) may be transmitted to other modules (e.g., the determination module 430) to be further processed.

The training module 420 may be configured to determine a plurality of trained sub-end-point regions that may be used to determine a target region and/or a target link associated with the service request. The training module 420 may determine the plurality of trained sub-end-point regions based on a plurality of historical service orders occurred in an end-point region (e.g., a vicinity of a building, a park, a shopping mall etc.). For example, the training module 420 may determine a plurality of sample service end-point locations (e.g., a sample start location, a sample destination) and a plurality of sample service end-point links (e.g., a sample start road link corresponding to a sample start location, a sample end road link corresponding a sample destination) associated with the plurality of historical service orders. The training module 420 may obtain a plurality of preliminary sub-end-point regions and train the plurality of preliminary sub-end-point regions based on the plurality of sample service end-point locations and the plurality of sample service end-point links. The plurality of trained sub-end-point regions may be transmitted to the determination module 430 or may be stored in any storage device (e.g., the storage 150) disclosed elsewhere in the present disclosure.

The determination module 430 may be configured to determine a target region and/or a target link associated with the service request based on the plurality of trained sub-end-point regions. For example, the determination module 430 may select a sub-end-point region from the plurality of trained sub-end-point regions as the target region according to geographic coordinate information of the target location of the service request. As another example, the determination module 430 may determine a sample service end-point link that is located in the target region as the target link. In some embodiments, the determination module 430 may further determine recommended information associated with the service request based on the target link and/or the target region. The recommended information may include a recommended driving route that starts or ends at the target link, an ETA of the service request, etc.

The communication module 440 may be configured to transmit the recommended information associated with the service request to the requestor terminal 130, the provider terminal 140, the storage 150, and/or any other device associated with the on-demand service system 100. In some embodiments, the recommended information may be transmitted to the requestor terminal 103 and/or the provider terminal 140 to be displayed via a user interface (e.g., the display 320). In some embodiments, the recommended information may be displayed in a format of, for example, text, images, audios, videos, etc. In some embodiments, the communication module 440 may transmit the recommended information to any device via a suitable communication protocol (e.g., the Hypertext Transfer Protocol (HTTP), Address Resolution Protocol (ARP), Dynamic Host Configuration Protocol (DHCP), File Transfer Protocol (FTP), etc.).

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the obtaining module 410 and the determination module 430 may be combined as a single module which may both obtain a service request and determine a target region, a target link, and/or recommended information associated with the service request based on a plurality of trained sub-end-point regions. As another example, the processing engine 112 may include a storage module (not shown) used to store the service request, the plurality of trained sub-end-point regions, the target region, the target link, the recommended information, and/or any information associated with the service request. As a further example, the modules in the processing engine 112 may include a storage unit (not shown) respectively.

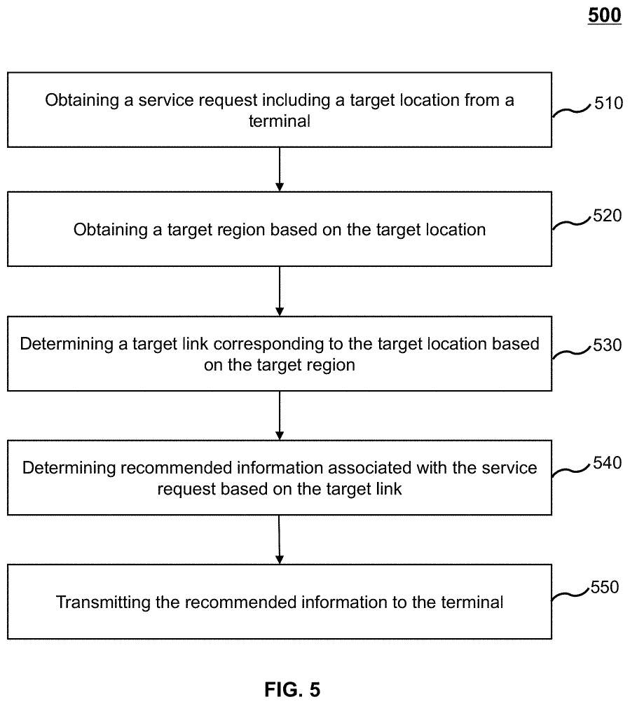

FIG. 5 is a flowchart illustrating an exemplary process for determining recommended information associated with a service request according to some embodiments of the present disclosure. The process 500 may be executed by the on-demand service system 100. For example, the process 500 may be implemented as a set of instructions (e.g., an application) stored in the storage ROM 230 or RAM 240. The processor 220 may execute the set of instructions, and when executing the instructions, it may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process as illustrated in FIG. 5 and described below is not intended to be limiting.

In step 510, the processing engine 112 may obtain a service request including a target location from the requestor terminal 130.

The processing engine 112 may obtain the service request from the requestor terminal 130 via the network 120. The service request may be a request for a transportation service (e.g., a taxi service). The target location may include a start location and/or a destination, etc. As used herein, the start location generally refers to a location where the requestor wishes to start receiving the service (e.g., a location to be picked up by a service provider). The destination generally refers to a location where the requestor wishes the service to be ended (e.g. a location to be dropped off by the service provider). In some embodiments, the service request may further include a start time. As used herein, the start time generally refers to a time point when the requestor wishes to use the transportation service.

The service request may include a real-time request, an appointment request, and/or any other request for one or more types of services. As used herein, the real-time request may indicate that the requestor wishes to use a transportation service at the present moment or at a defined time reasonably close to the present moment for an ordinary person in the art, so that the service provider is required to immediately or substantially immediately act to provide the service. For example, a request may be a real-time request if the defined time is shorter than a threshold value, such as 1 minute, 5 minutes, 10 minutes, 20 minutes, etc. The appointment request may indicate that the requestor wishes to schedule a transportation service in advance (e.g., at a defined time which is reasonably far from the present moment for the ordinary person in the art), so that the service provider is not required to immediately or substantially immediately act to provide the service. For example, a request may be an appointment request if the defined time is longer than a threshold value, such as 20 minutes, 2 hours, 1 day, etc. In some embodiments, the processing engine 112 may define the real-time request or the appointment request based on a time threshold. The time threshold may be default settings of the on-demand service system 100 or may be adjustable in different situations. For example, in a traffic peak period, the time threshold may be relatively small (e.g., 10 minutes). In an idle period (e.g., 10:00-12:00 am), the time threshold may be relatively large (e.g., 1 hour).

In step 520, the processing engine 112 may obtain a target region based on the target location.

For example, the target location may locate in a predetermined area. When the target location is an end-point location of the service (i.e., the start location and/or the destination), the predetermined area is also called an end-point region. The end-point region may include a plurality of sub-end-point regions trained by the on-demand system 100 in advance. Details of training and/or obtaining the plurality of sub-end-point regions may be found elsewhere in the present disclosure. In some embodiments, the processing engine 112 may obtain the target region based on the plurality of trained sub-end-point regions. For example, the processing engine 112 may obtain geographic coordinate information (e.g., longitude coordinate, latitude coordinate) of the target location, and then may select a sub-end-point region from the plurality of trained sub-end-point regions in which the target location falls as the target region.

In some embodiments, the processing engine 112 may determine the plurality of trained sub-end-point regions based on a plurality of historical service orders. The processing engine 112 may determine a plurality of preliminary sub-end-point regions based on a geohash algorithm, and train the plurality of preliminary sub-end-point regions based on a plurality of sample service end-point locations and a plurality of sample service end-point links associated with the plurality of historical service orders.

In step 530, the processing engine 112 may determine a target link corresponding to the target location based on the target region.

In this disclosure, a “link” may refer to a section of a road or a street. A “start link” may refer to a link associated with a start location. For example, a start link may be a start road section of the transportation service requested by the requestor. In this disclosure, the “start link” also may be referred to as “start road link.” For illustration purposes, the present disclosure uses a pick-up location corresponding to the start location as an example of the start link.

The “pick-up location” generally refers to a location where a vehicle can stop to pick up a subject of the service, such as a requestor or goods. The pick-up location may be the same as or different from the start location. In response to a determination that the start location is a location where a vehicle cannot stop, the processing engine 112 may determine a suitable location near the start location as a pick-up location. Further, a link including the pick-up location may be determined as the start link.

An “end link” may refer to an end road section of the transportation service requested by the requestor. For example, the end link may be a road section associated with a destination of the transportation service. In this disclosure, the “end link” also may be referred to as “end road link.” For illustration purposes, the present disclosure uses a drop-off location corresponding to the destination as an example of the end link.

The “drop-off location” generally refers to a location where a vehicle can stop to drop off the subject of the transportation service, such as the requestor and/or the goods. The drop-off location may be the same as or different from the destination. In response to a determination that the destination is a location where a vehicle cannot stop, the processing engine 112 may determine a suitable location near the destination as a drop-off location. Further, a link including the drop-off location may be determined as the end link. In this disclosure, the start link and the end link may be collectively referred to as “end-point link.” The start location and the destination may be collectively referred to as “end-point location.”

As described in connection with step 520, the processing engine 112 may select the target region from the plurality of trained sub-end-point regions. As used herein, each of the plurality of trained sub-end-point regions may correspond to a single end-point link, which indicates that a predetermined percentage (e.g., 100%) of historical service orders were associated with the single end-point link. After obtaining the target region, the processing engine 112 may determine the single corresponding end-point link as the target link. In some embodiments, the processing engine 112 may determine a start link corresponding to the start location and an end link corresponding to the destination based on the plurality of trained sub-end-point regions respectively.

In step 540, the processing engine 112 may determine recommended information associated with the service request based on the target link. The recommended information may include a recommended driving route that starts or ends at the target link, an estimated time of arrival (ETA) of the service request, etc. For example, the processing engine 112 may determine the recommended driving route based on the start location, the start link, the end link, and the destination. As another example, the processing engine 112 may determine the ETA based on the recommended driving route and/or traffic information (e.g., traffic speed, traffic flow, traffic density) associated with the service request.

In step 550, the processing engine 112 may transmit the recommended information to the requestor terminal 130 and/or the provider terminal 140 via the network 120. In some embodiments, the processing engine 112 may save the recommended information into a storage device (e.g., the storage 150) as disclosed elsewhere in the present disclosure.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 500. In the storing step, the processing engine 112 may store the service request, the target region, the target link, and/or the recommended information associated with the service request in a storage device (e.g., the storage 150) disclosed elsewhere in the present disclosure. As another example, step 520 and step 530 may be combined into a single step in which the processing engine 112 may both obtain the target region and the target link.

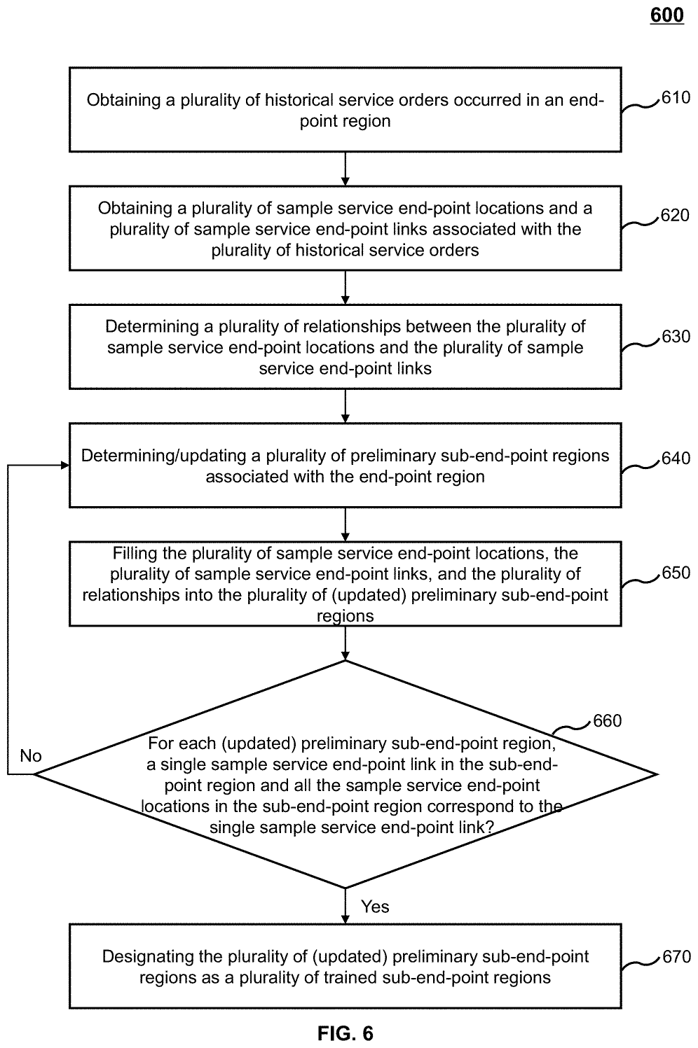

FIG. 6 is a flowchart illustrating an exemplary process for determining a plurality of trained sub-end-point regions according to some embodiments of the present disclosure. In some embodiments, step 520 and/or step 530 of process 500 may be performed based on an exemplary process 600 illustrated in FIG. 6. The process 600 may be executed by the on-demand service system 100. For example, the process 600 may be implemented as a set of instructions (e.g., an application) stored in the storage ROM 230 or RAM 240. The processor 220 may execute the set of instructions and, when executing the instructions, it may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process as illustrated in FIG. 6 and described below is not intended to be limiting.

In step 610, the processing engine 112 may obtain a plurality of historical service orders occurred in an end-point region. The end-point region may be an area, for example, Washington D.C. area, a ten-mile radius area centered at the Capital Hill, etc. In some embodiments, the processing engine 112 may obtain the plurality of historical service orders from the storage 150 via the network 120. In some embodiments, the processing engine 112 may obtain the plurality of historical service orders from a storage module (not shown) in the processing engine 112.

As used herein, a “historical service order” may refer to a service request that has been completed and the information associated therein. For example, for the application scenario illustrated in FIG. 1, a requestor may send a service request including an end-point location (e.g., a start location, a destination) for a transportation service to the on-demand service system 100. A service provider may accept the service request and provide the transportation service along a driving route that travels from a pick-up location to a drop-off location. After the service provider drops off the requestor at the drop-off location, the on-demand service system 100 may store information associated with the service request (e.g., the start location, the destination, the driving route, the pick-up location, the drop-off location) in a storage device (e.g., the storage 150) disclosed elsewhere in the present disclosure.

In some embodiments, the plurality of historical service orders may be selected based on a temporal criterion. For example, the plurality of historical service orders may be selected within a predetermined time period, for example, the past six months, the past week, from 8:00 am to 9:00 am every day for six months, etc. In some embodiments, the plurality of historical service orders may be selected with respect to one or more parameters, for example, the vehicle type, the start location, the destination, the passenger profile, the driver profile, the service charge, etc.

In step 620, the processing engine 112 may obtain a plurality of sample service end-point locations and a plurality of sample service end-point links associated with the plurality of historical service orders. The plurality of sample service end-point locations may refer to historical service end-point locations in the plurality of historical service orders. The plurality of sample service end-point links may refer to historical service end-point links in the plurality of historical service orders. The sample service end-point location may include a sample start location, a sample destination, etc. The sample service end-point link may include a sample start link, a sample end link, etc. In some embodiments, the processing engine 112 may obtain the plurality of sample service end-point links from a plurality of historical driving routes associated with the plurality of historical service orders.

In step 630, the processing engine 112 may determine a plurality of relationships between the plurality of sample service end-point locations and the plurality of sample service end-point links. Each of the plurality of relationships may refer to a mapping relationship between a sample service end-point location and a sample service end-point link. In some embodiments, for each of the plurality of historical service orders, the processing engine 112 may determine a pick-up location (hereafter referred to as a “sample pick-up location”) and a drop-off location (hereafter referred to as a “sample drop-off location”). As used herein, the pick-up location generally refers to a location where the service provider picked up the requestor. The drop-off location generally refers to a location where the service provider dropped off the requestor.

In some embodiments, the processing engine 112 may determine a plurality of first relationships between the plurality of sample start locations and the plurality of sample start links. The processing engine 112 may determine the plurality of first relationships based on geographic coordinate information of a plurality of sample pick-up locations corresponding to the plurality of sample start locations and geographic coordinate information of the plurality of sample start links. In some embodiments, the processing engine 112 may determine the geographic coordinate information according to a geohash algorithm.

For a sample start location, the processing engine 112 may determine a geographic coordinate of a corresponding sample pick-up location as illustrated below:

Gₚ=(m,n), (1)

where Gₚ may refer to a geographic coordinate of a sample pick-up location, m may refer to a longitude coordinate of the sample pick-up location, and n may refer to a latitude coordinate of the sample pick-up location.

For a sample start link, the processing engine 112 may determine a geographic coordinate range of the sample start link as illustrated below:

Gₛ={(a₁,b₁),(a₂,b₂), . . . ,(aₙ,bₙ)}, (2)

where Gₐ may refer to a geographic coordinate range of a sample start link, and (aₙ, bₙ) may refer to a geographic coordinate of a location point that is within the sample start link.

For illustration purposes, for a specific sample start location P, the processing engine 112 may determine a corresponding sample pick-up location Q. The processing engine 112 may further determine a geographic coordinate of the sample pick-up location Q and in response to a determination that the geographic coordinate of the sample pick-up location Q is within a geographic coordinate range of a sample start link L_{S}, the processing engine 112 may determine a first relationship between the sample start location P and the sample start link L_{S}.

In some embodiments, the processing engine 112 may determine a plurality of second relationships between the plurality of sample destinations and the plurality of sample end links. Similar to the plurality of first relationships, the processing engine 112 may determine the plurality of second relationships based on geographic coordinate information of a plurality of sample drop-off locations corresponding to the plurality of sample destinations and geographic coordinate information of the plurality of sample end links.

For a sample destination, the processing engine 112 may determine a geographic coordinate of a corresponding sample drop-off location as illustrated below:

G_{d}=(s,t), (3)

where G_{d} may refer to a geographic coordinate of a sample drop-off location, s may refer to a longitude coordinate of the sample drop-off location, and t may refer to a latitude coordinate of the sample drop-off location.

For a sample end link, the processing engine 112 may determine a geographic coordinate range of the sample end link as illustrated below:

Gₑ={(c₁,d₁),(c₂,d₂), . . . ,(cₙ,dₙ)} (4)

where Gₑ may refer to a geographic coordinate range of a sample end link, and (cₙ, dₙ) may refer to a geographic coordinate of a location point that is within the sample end link.

For illustration purposes, for a specific sample destination E, the processing engine 112 may determine a corresponding sample drop-off location F. The processing engine 112 may further determine a geographic coordinate of the sample drop-off location F and in response to a determination that the geographic coordinate of the sample drop-off location F is within a geographic coordinate range of a sample end link L_{D}, the processing engine 112 may determine a second relationship between the sample destination E and the sample end link L_{D}.

In step 640, the processing engine 112 may determine a plurality of preliminary sub-end-point regions associated with the end-point region. Each of the plurality of preliminary sub-end-point regions may be a regular area (e.g., a rectangular area, a circular area) or an irregular area (e.g., an irregular polygon). The processing engine 112 may segment the end-point region into the plurality of preliminary sub-end-point regions according to a segmentation approach. For example, the processing engine 112 may segment the end-point region into the plurality of preliminary sub-end-point regions based on a geohash algorithm. The processing engine 112 may segment the end-point region into a plurality of polygons (i.e., the plurality of preliminary sub-end-point regions) according to geographic coordinate information (e.g., geohash information) of the end-point region. In some embodiments, the processing engine 112 may segment the end-point region according to a precision (e.g., 10 meters, 20 meters, 50 meters, 100 meters). The precision may be default settings of the on-demand service system 100, or may be adjustable depending on different situations.

In step 650, the processing engine 112 may fill the plurality of sample service end-point locations, the plurality of sample service end-point links, and the plurality of relationships into the plurality of preliminary sub-end-point regions according to geographic coordinate information (e.g., geohash information) thereof.

In step 660, the processing engine 112 may determine, for each preliminary sub-end-point region, whether a single sample service end-point link is in the sub-end-point region and whether all the sample service end-point locations in the sub-end-point region correspond to the single sample service end-point link.

In response to the determination that for each preliminary sub-end-point region, a single sample service end-point link is in the sub-end-point region and all the sample service end-point locations correspond to the single service end-point link, the processing engine 112 may designate the plurality of preliminary sub-end-point regions as the plurality of trained sub-end-point regions in step 670. As used herein, “a single sample service end-point link in the sub-end-point region” indicates that a predetermined percentage of historical service orders started or ended corresponding services at the sample service end-point link. In ideal conditions, the predetermined percentage is 100%. In actual operation, there may be some special cases, for example, a requestor change the pick-up location temporarily, which may affect the relationship between the sample service end-point location (e.g., a sample start location) and the sample service end-point link (e.g., a sample start link). During the training of the plurality of sub-end-point regions, the processing engine 112 may filter the special cases. For convenience, in this disclosure, we assume that the special cases didn't exist.

In response to the determination that for each preliminary sub-end-point region, not a single sample service end-point link is in the sub-end-point region or not all the sample service end-point locations correspond to a single service end-point link in the sub-end-point region, the processing engine 112 may execute the process 600 to return back to step 640 to update the plurality of preliminary sub-end-point regions until for each sub-end-point region, a single sample service end-point link is in the sub-end-point region and all the sample service end-point locations correspond to the single service end-point link.

For example, the processing engine 112 may further segment the plurality of preliminary sub-end-point regions based on the plurality of relationships between the plurality of sample service end-point locations and the plurality of sample service end-point links. Further, in response to the determination that for each updated sub-end-point region, a single sample service end-point link is in the sub-end-point region and all the sample service end-point locations correspond to the single service end-point link, the processing engine 112 may designate the plurality of updated sub-end-point regions as the plurality of trained sub-end-point regions. On the other hand, in response to the determination that for each update sub-end-point region, not a single sample service end-point link is in the sub-end-point region or not all the sample service end-point locations correspond to a single service end-point link in the sub-end-point region, the processing engine 112 may execute the process 600 to return back to step 640 to further update the plurality of sub-end-point regions.

The iteration from steps 640 through 660 may continue until the processing engine 112 determines that under newly updated sub-end-point regions, for each sub-end-point region, a single sample service end-point link is in the sub-end-point region and all the sample service end-point locations correspond to the single service end-point link, and the processing engine 112 may designate the plurality of updated sub-end-point regions as the plurality of trained sub-end-point regions.

In some embodiments, the processing engine 112 may store the plurality of trained sub-end-point regions in a storage device (e.g., the storage 150) disclosed elsewhere in the present disclosure. In some embodiments, the processing engine 112 may update the plurality of trained sub-end-point regions dynamically according to a specific time period (e.g., a month, two months, a year).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 600. As another example, step 610 and step 620 may be combined as a single step in which the processing engine 112 may obtain a plurality of historical service orders, a plurality of sample service end-point locations, and a plurality of sample service end-point links associated with the plurality of historical service orders together.

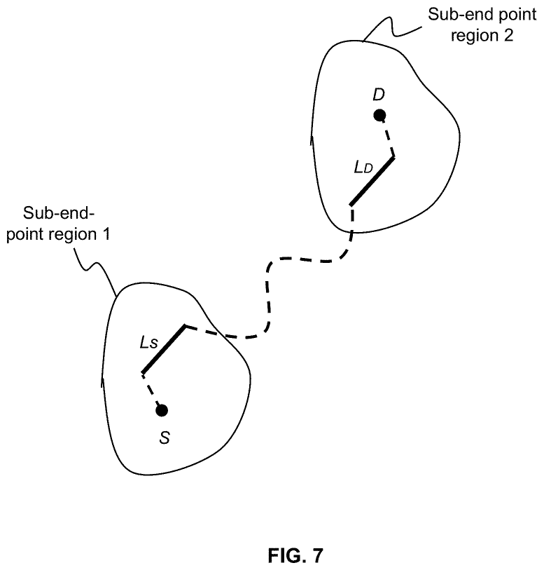

FIG. 7 is a schematic diagram illustrating an example for determining a recommended driving route associated with a service request based on a plurality of trained sub-end-point regions according to some embodiments of the present disclosure. As illustrated, a service request includes a start location S and a destination D. After receiving the service request, the processing engine 112 may determine a sub-end-point region 1 corresponding to the start location S and a sub-end-point region 2 corresponding to the destination D. As described in connection with FIG. 6, each of the plurality of sub-end-point regions corresponds to a single end-point link. For the sub-end-point region 1, it corresponds to a start link Lₛ. For the sub-end-point region 2, it corresponds to an end link L_{D}. The processing engine 112 may further determine a recommended driving route based on the start link Lₛ and the end link L_{D}.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
at least one storage medium including a set of instructions for determining recommended information of a service request;
at least one processor in communication with the at least one storage medium, wherein when executing the set of instructions, the at least one processor is directed to:
obtain a service request from a terminal via a network, the service request including a target location;
obtain a target region based on the target location, wherein the target region is associated with a target link so that a predetermined percentage of historical service orders associated with the target region is associated with the target link;
determine recommended information associated with the service request based at least in part on the target link; and
send out the recommended information to the terminal via the network.

2. The system of claim 1, wherein the target location includes at least one of a start location or a destination, and the target link corresponds to a road section associated with the target location.

3. The system of claim 2, wherein the recommended information includes a recommended driving route that starts or ends at the road section corresponding to the target link.

4. The system of claim 1, wherein the predetermined percentage is 100%.

5. The system of claim 1, wherein the at least one processor is further directed to:
obtain a plurality of historical service orders, each of the plurality of historical service orders including a sample service end-point location in an end-point region associated with the historical service order, wherein the sample service end-point location corresponds to a sample service end-point link where a corresponding service of the historical service order started or ended; and
determine a plurality of sub-end-point regions within the end-point region based at least in part on the plurality of sample service end-point locations and the plurality of sample service end-point links, wherein each sub-end-point region is associated with a single corresponding end-point link so that the predetermined percentage of the plurality of historical service orders started or ended corresponding services at the single corresponding end-point link.

6. The system of claim 5, wherein the target link is one of the plurality of single corresponding end-point links, and the target region is one of the plurality of sub-end-point regions where the target location falls in.

7. The system of claim 5, wherein to determine the plurality of sub-end-point regions within the end-point region, the at least one processor is directed to:
determine a plurality of preliminary sub-end-point regions within the end-point region;
determine a plurality of relationships between the plurality of sample service end-point locations and the plurality of service end-point links;
fill the plurality of sample service end-point locations and the plurality of sample service end-point links into the plurality of preliminary sub-end-point regions; and
for each of the plurality of preliminary sub-end-point regions,
determine whether a single sample service end-point link is in the sub-end-point region and whether all the sample service end-point locations in the sub-end-point region correspond to the single sample service end-point link based on the plurality of relationships; and
designate the plurality of preliminary sub-end-point regions as the plurality of sub-end-point regions in response to the determination that a single sample service end-point link is in the sub-end-point region and all the sample service end-point locations in the sub-end-point region correspond to the single sample service end-point link based on the plurality of relationships.

8. A method implemented on a computing device having at least one processor, at least one storage medium, and a communication platform connected to a network, comprising:
obtaining, by the at least one processor, a service request from a terminal via a network, the service request including a target location;
obtaining, by the at least one processor, a target region based on the target location, wherein the target region is associated with a target link so that a predetermined percentage of historical service orders associated with the target region is associated with the target link;
determining, by the at least one processor, recommended information associated with the service request based at least in part on the target link; and
sending out, by the at least one processor, the recommended information to the terminal via the network.

9. The method of claim 8, wherein the target location includes at least one of a start location or a destination, and the target link corresponds to a road section associated with the target location.

10. The method of claim 9, wherein the recommended information includes a recommended driving route that starts or ends at the road section corresponding to the target link.

11. The method of claim 8, wherein the predetermined percentage is 100%.

12. The method of claim 8, further comprising:
obtaining, by the at least one processor, a plurality of historical service orders, each of the plurality of historical service orders including a sample service end-point location in an end-point region associated with the historical service order, wherein the sample service end-point location corresponds to a sample service end-point link where a corresponding service of the historical service order started or ended; and
determining, by the at least one processor, a plurality of sub-end-point regions within the end-point region based at least in part on the plurality of sample service end-point locations and the plurality of sample service end-point links, wherein each sub-end-point region is associated with a single corresponding end-point link so that the predetermined percentage of the plurality of historical service orders started or ended corresponding services at the single corresponding end-point link.

13. The method of claim 12, wherein the target link is one of the plurality of single corresponding end-point links, and the target region is one of the plurality of sub-end-point regions where the target location falls in.

14. The method of claim 12, further comprising:
determining, by the at least one processor, a plurality of preliminary sub-end-point regions within the end-point region;
determining, by the at least one processor, a plurality of relationships between the plurality of sample service end-point locations and the plurality of service end-point links;
filling, by the at least one processor, the plurality of sample service end-point locations and the plurality of sample service end-point links into the plurality of preliminary sub-end-point regions; and
for each of the plurality of preliminary sub-end-point regions,
determining, by the at least one processor, whether a single sample service end-point link is in the sub-end-point region and whether all the sample service end-point locations in the sub-end-point region correspond to the single sample service end-point link based on the plurality of relationships; and
designating, by the at least one processor, the plurality of preliminary sub-end-point regions as the plurality of sub-end-point regions in response to the determination that a single sample service end-point link is in the sub-end-point region and all the sample service end-point locations in the sub-end-point region correspond to the single sample service end-point link based on the plurality of relationships.

15. A non-transitory computer readable medium, comprising a set of instructions for determining recommended information of a service request, wherein when executed by at least one processor, the set of instructions directs the at least one processor to perform acts of:
obtaining a service request from a terminal via a network, the service request including a target location;
obtaining a target region based on the target location, wherein the target region is associated with a target link so that a predetermined percentage of historical service orders associated with the target region is associated with the target link;
determining recommended information associated with the service request based at least in part on the target link; and
sending out the recommended information to the terminal via the network.

16. The non-transitory computer readable medium of claim 15, wherein the target location includes at least one of a start location or a destination, and the target link corresponds to a road section associated with the target location.

17. The non-transitory computer readable medium of claim 16, wherein the recommended information includes a recommended driving route that starts or ends at the road section corresponding to the target link.

18. The non-transitory computer readable medium of claim 15, wherein the predetermined percentage is 100%.

19. The non-transitory computer readable medium of claim 15, wherein the set of instructions further directs the at least one processor to perform acts of:
obtaining a plurality of historical service orders, each of the plurality of historical service orders including a sample service end-point location in an end-point region associated with the historical service order, wherein the sample service end-point location corresponds to a sample service end-point link where a corresponding service of the historical service order started or ended; and
determining a plurality of sub-end-point regions within the end-point region based at least in part on the plurality of sample service end-point locations and the plurality of sample service end-point links, wherein each sub-end-point region is associated with a single corresponding end-point link so that the predetermined percentage of the plurality of historical service orders started or ended corresponding services at the single corresponding end-point link.

20. The non-transitory computer readable medium of claim 19, wherein the target link is one of the plurality of single corresponding end-point links, and the target region is one of the plurality of sub-end-point regions where the target location falls in.

21. (canceled)
